(19) United States
(12) Patent Application Publication
(10) Pub. No.: US 2023/0170725 A1
(43) Pub. Date: Jun. 1, 2023

(54) SYSTEMS, METHODS AND DEVICES FOR MANAGING ENERGY STORAGE DEVICES AT OPERATING TEMPERATURE LIMITS

(71) Applicant: Dragonfly Energy Corp., Reno, NV (US)

(72) Inventor: William A. Thomason, Friday Harbor, WA (US)

(73) Assignee: Dragonfly Energy Corp., Reno, NV (US)

(21) Appl. No.: 17/539,022

(22) Filed: Nov. 30, 2021

(51) Int. Cl. H02J 7/00; H01G 11/18; H01M 10/44; H01M 10/46; H01M 10/615; H01M 10/48

(52) U.S. Cl. CPC H02J 7/007194; H02J 7/0068; H02J 7/0047; H02J 7/00032; H01G 11/18; H01M 10/443; H01M 10/46; H01M 10/615; H01M 10/486; H02J 2207/50; H02J 2207/20

(57) ABSTRACT

Systems, methods and devices for managing power systems and energy storage devices, such as a rechargeable batteries, at operational temperature limits of the energy storage device. The systems control the operation of a charging device in a low temperature operating mode below a charging low temperature limit of the energy storage device at which the energy storage device may be damaged or dangerous if in a charging state. The system controls a current output of the charging device to provide at least some of the power required to power a heater which heats the energy storage device while at the same time avoiding the energy storage device going into a charging state, based on the one or more sensor signals.

### BACKGROUND

The field of the invention generally relates to power charging systems for charging an energy storage device, and more particularly, to systems, methods and devices for managing a power charging system and energy storage device, such as a rechargeable battery, at the operational temperature limits of the storage device, such as at low temperature limits and/or high temperature limits.

Rechargeable energy storage devices, such as rechargeable electrochemical batteries, are capable of delivering energy stored in the devices by discharging the storage, and then being charged by inputting energy from a power charging source into the devices, also referred to as recharging the devices. For instance, rechargeable electrochemical batteries discharge energy by converting stored chemical energy outputted into electrical energy, and are charged by inputting electrical energy from a battery charger device which is converted back into stored chemical energy. Such energy storage devices, especially electrochemical batteries may have operational temperature limits. For example, Li-ion batteries have low temperature limits for discharging the battery and for charging the battery. Typical Li-ion batteries have a charging low temperature limit of about 0° C., because charging at temperatures below 0° C. damages the internal structure of the Li-ion batteries and/or may create a risk of dangerous conditions such as explosion of the batteries. Indeed, many Lithium chemistry batteries exhibit reduced charging capabilities as the temperature approaches 0° C. , and below 0° C. charging must be disabled to prevent damage to the battery. Accordingly, at temperatures below 0° C., the battery charger must be turned off and/or disconnected from the batteries to avoid damaging the batteries.

Typical Li-ion batteries also have a discharge low temperature limit of about −20° C., because discharge at temperatures below −20° C. may also damage the batteries and/or pose dangerous conditions. Li-ion batteries may also have a charging high temperature limit of about 45° C., and a discharging high temperature limit of about 60° C. The damage to the Li-ion batteries may include a decrease in maximum storage capacity, decreased performance (e.g., decreased power output), diminished lifecyle (number of charge and discharge cycles of battery causing loss of performance) and/or total battery failure.

Other types of batteries made with different chemistries may also have these types of operational temperature limits, but such limits may be at different temperatures. For instance, lead-acid batteries can be safely charged and discharged at temperatures from about −20° C. to about 50° C. without damaging the batteries or creating unsafe conditions. Outside this temperature range, lead-acid batteries may exhibit degraded performance, and/or may be damaged.

Several adaptions for dealing with the low temperature limit(s) of Li-ion batteries have been utilized. In some prior systems, the Li-ion battery is simply not charged below 0° C., such as by disconnecting the battery from its charging source, or shutting off the charging source. In some applications, the batteries are located in a climate controlled compartment, such as in a passenger compartment of a vehicle to heat and maintain the battery above the low temperature limit(s).

In still other systems, the battery is fitted with heaters to warm and maintain the battery above the low temperature limit(s), thereby allowing for battery charging and/or discharging in lower ambient temperatures, without limitations on the location of the battery. In order to ensure that the batteries do not enter a charging state when below the charging low temperature limit (about 0° C. for Li-ion batteries),in many cases the heaters are powered by the internal battery energy reserves as the power source, rather than the battery charger. For example, if the battery charger is used to power the heaters, which is also connected to the battery, then the power provided may exceed the power draw of the heaters such that the excess power results in the battery going into a charging state. However, powering the heaters with the battery results in a reduction of the state of charge of the battery. Accordingly, the battery energy used to power the heaters must then be replaced at a later time (i.e., when the battery temperature is above the charging low temperature limit) by the battery charger. This process introduces inefficiencies due to the multi-step energy conversion process of a discharge cycle to power the heaters followed by a charge cycle, as well as reduced battery life due to increased discharge/recharge cycles. Moreover, the time to charge the battery is extended to account for the extra energy extracted by powering the heaters.

Accordingly, there is a need for systems, methods, and devices which provides for more efficient use of battery energy, especially in cold temperature environments.

### SUMMARY

The presently disclosed inventions are directed to systems, methods and devices for managing power systems and energy storage devices, such as a rechargeable batteries, at operational temperature limits of the energy storage device. For example, many rechargeable batteries, including Li-ion batteries which are very commonly used in high energy storage applications, have operating temperature limits wherein the batteries should not be discharged or charged, otherwise they may be damaged and/or dangerous. Li-ion batteries have a charging low temperature limit (about 0° C.) below which the batteries cannot be charged, and a discharging low temperature limit (about −20° C.) below which the batteries cannot be discharged (i.e., the stored energy cannot be used to provide power), without damaging the batteries and/or creating a dangerous condition, such as risk of fire or explosion. Some energy storage devices may also have high temperature limits above which such devices should not be discharged and/or charged.

The energy storage device, such as batteries, are also rechargeable. In other words, when the stored energy with the energy storage device is used, the energy storage device can be recharged by using a charging device to put energy back into the energy storage device which is then stored in the energy storage device. For example, electrochemical batteries are recharged by applying electrical current at a charging voltage to the batteries using a battery charger or generator such as an alternator. However, as explained herein, certain energy storage devices have charging low temperature limits at which the devices should not be charged.

Accordingly, in order to operate energy storage devices in ambient conditions outside of their safe operating temperature ranges, heaters or cooling devices (i.e., environmental controls) may be provided to heat or cool the energy storage device to its safe operating temperature range. For example, an electrochemical battery, such as a Li-ion battery, may be fitted with a heater to warm the battery and maintain its temperature above its low temperature limits. Hence, when the ambient temperature falls below 0° C. and the Li-ion battery temperature approaches or is below the charging low temperature limit of about 0° C., the heater turns on to maintain the battery at or above the charging low temperature limit.

As explained herein, in prior systems, the battery has often been used to power the heater, which introduces inefficiencies in the cyclic use of the battery. One reason for the use of this configuration is that when the battery is in the low temperature operating condition, if the charging device were to be used to power the heater, it runs the risk of putting the battery into a charging mode, which can damage the battery and create a hazardous condition of the battery. As an example, if the charging device outputs 15 amps of current to the battery and connected heater, and the heater draws only 10 amps (i.e., less than the current output by the charging device), then the battery will be in a charging state of 5 amps, but the battery should not be charged when in the low temperature operating condition. Accordingly, in prior power systems having a rechargeable battery, the battery is used to power the heater when the temperature is below the charging low temperature limit, and the charging device is either turned off, or disconnected by a switch. Hence, the battery energy used to power the heaters must be replenished by charging the battery, which extends the time required to charge the battery to account for the energy used power the heater.

The presently disclosed systems, methods and devices overcome these deficiencies of prior systems by utilizing the charging device to provide at least some of the power used by the heater while in a low temperature operating mode below the charging low temperature limit of the energy storage device, while also avoiding a positive current input to the energy storage device, thereby preventing the charging device from going into a charging state. In some embodiments, the charging device may be used to provide all, or substantially all, of the power used by the heater while in a low temperature operating mode below the charging low temperature limit.

Therefore, in one embodiment according to the presently disclosed inventions, a power charging system includes a rechargeable energy storage device, a charging device, a controller, and a heater. The rechargeable energy storage device is configured to deliver stored energy and to be recharged by inputting energy into the energy storage device. The rechargeable energy storage device has a charging low temperature limit wherein the energy storage device is not to be charged below the charging low temperature limit. For instance, the energy storage device may be any suitable energy storage device, such as an electrochemical battery electrochemical battery, a supercapacitor battery, a solid-state battery. The energy storage device may output electrical power, such as for powering electrical devices like appliances, lighting, heating, ventilation and air conditioning (HVAC), and other electrical devices.

The heater is thermally coupled to the energy storage device for heating the energy storage device. The heater is also operably coupled to the energy storage device and the charging device for providing power to the heater.

The charging device is operably coupled to the energy storage device and is configured to recharge the energy storage device. The charging device may be any suitable charging device for charging the energy storage device. For example, in certain aspects, the charging device may be an alternator, an alternator and converter, a generator, a power supply or other source of power.

The controller is operably coupled to the charging device. The controller is configured to control the operation of the charging device by receiving one or more sensor signals configured to detect operational conditions of the power system. The controller has a low temperature operating mode when the energy storage device temperature is below a charging low temperature set point. The charging low temperature set point is a temperature at or above the charging low temperature limit, such that the set point may provide some safety margin above the limit. In the low temperature operating mode, the heater is powered on. In the low temperature operating mode, the controller is configured to control current output of the charging device to provide at least some of the power required to power the heater while at the same time avoiding a positive current input to the energy storage device, based on the one or more sensor signals. In other words, the controller controls the current output of the charging device so that the charging device provides at least some power to the heater, and also keeps the current output of the charging device below a level that would result in a positive current input to the energy storage device, in which case the energy storage device would go into a charging state below the low temperature set point. For example, if the current output of the charging device flowing to the heater and energy storage device exceeds the current draw of the heater, then the energy storage device will go into a charging state. Accordingly, the controller may prevent the energy storage device from entering a charging state that could damage the battery and/or create a risk of a dangerous condition of the storage device.

In another aspect of the power system, in the low temperature operating mode, the controller may be configured to control the current output of the charging device to power the heater while maintaining a nominal current discharge of the energy storage device. In other words, the controller controls the current output of the charging device such that there is at least some small amount of current discharge of the energy storage device. Typically, the nominal current discharge is used to provide some of the power to the heater, but also may be used to power other devices. In other aspects, the nominal current discharge of the energy storage device may be set to 1 amp or less, or 2 amps or less, or 5 amps or less. In this way, the power draw from the energy storage device is limited, so that the amount of energy need to recharge the battery to replenish the energy used to power the heater is minimal, while also providing a margin of safety in ensuring that the energy storage device does not enter a charging state.

In still another aspect, the controller may be configured to control the current output of the charging device to provide at least a minimum amount of the power required to power the heater in the low temperature operating mode, such as at least 50% or more, or at least 60% or more, or at least 70% or more, or at least 75% or more, or at least 80% or more, or at least 90% or more of the power required to power the heater in the low temperature operating mode.

In another aspect, of the power system, the energy storage device may be an electrochemical battery, for example, a Li-ion battery, a lithium based battery, a lead-acid battery, a LiFePO4 battery, a Lithium-ion polymer battery, a lithium-titanate-oxide (LTO) battery, a nickel-cadmium battery, or a nickel-metal hydride battery.

In another aspect, the power system may further include a current sensor operably coupled to the energy storage device for detecting a current input or output of the energy storage device and providing a current sensor signal. In another feature, the current sensor may be operably connected to the controller and the current sensor provides the current sensor signal directly to the controller. In another aspect, the energy storage device may include a storage device management system (SDMS) which may monitor and control the operation of the battery. The SDMS may be operably coupled to the energy storage device, heater, and current sensor, and may be configured to receive the current sensor signal and transmit the sensor signal representative of the measured current to the controller. In either case, the controller may then use the sensor signal representative of the current sensor signal as one of the sensor signals in controlling the current output of the charging device in the low temperature operating mode.

In yet another aspect, the sensor signal may be transmitted digitally by the SDMS to the controller. In another feature, SDMS may in communication with the controller via a communication system, such as a controller area network (CAN), an Ethernet network or an RS-485 network.

In another aspect, the current sensor may be any suitable current sensor, such as an analog sensor, a shunt sensor, or a Hall-effect sensor.

In another aspect, the power system may further include a current sensor operably coupled to the controller and configured for detecting a total current from the charging device to the combination of the energy storage device and heater. The current sensor provides a current sensor signal representative of the measured current. The controller may then use the sensor signal representative of the current sensor signal as one of the sensor signals in controlling the current output of the charging device in the low temperature operating mode

In still another aspect, the power system may also have a temperature sensor operably coupled to the energy storage device for detecting the temperature of the energy storage device. The temperature sensor provides a temperature sensor signal representative of the detected temperature. The temperature sensor signal may be transmitted directly to the controller, or indirectly via the SDMS. The controller may then use the temperature sensor signal as one of the sensor signals in controlling the current output of the charging device in the low temperature operating mode.

In another aspect, the SDMS may be configured to determine a heater status, including whether the heater is on or off. For example, the SDMS may control the heater, including turning the heater on and off, based on the temperature of the energy storage device as detected by the temperature sensor. The SDMS may also be configured to transmit a heater status signal representative of the heater status to the controller. The controller may then use the heater status to the controller as one of the sensor signals in controlling the current output of the charging device in the low temperature operating mode. For instance, the controller may be programmed such that if the heater is on, the controller operates in the charging low temperature mode, as the heater on signal indicates that the temperature of the energy storage device is below the charging low temperature set point.

In additional aspects, the charging device may be an alternator mounted in a vehicle, such as a chassis alternator also used to power the vehicle's electrical systems, or a dedicated alternator used only as the charging device for the energy storage device. A vehicle may be any type of vehicle, including without limitation, a car, a truck, a boat, a tractor-trailer, a trailer of a tractor trailer, a tractor of a tractor-trailer, etc. In still another aspect, the charging device may comprise an alternator and a power conversion device, such as a DC-DC converter, a DC-AC converter, an AC-DC converter, a pulse width modulation controller, a current limiting wire, and a current limiting self-resetting device. Thus, the power conversion device converts the output of the alternator into a suitable form of electrical power for charging the energy storage device. In yet another aspect, the charging device may comprise a power source and a converter, wherein the power source may be an AC powered battery charger, a solar maximum power point tracking (MPPT) charger, a secondary energy storage device (which may be any of the types of energy storage devices described herein), and the converter may be a DC-DC converter, or an AC-DC converter.

Another embodiment of the presently disclosed inventions is directed to a subsystem, also referred to as a control system, for the power systems disclosed herein. The subsystem may be an assembled device or module, or it may be a kit comprising a plurality of devices and/or module which can be assembled, connected, and/or installed into a power charging system. For instance, the subsystem may be installed into a power system having a charging device and energy storage device.

Accordingly, in one embodiment, a subsystem is disclosed for a power system comprising a charging device operably coupled to an energy storage device and a heater coupled to the energy storage device for heating the energy storage device, the heater operably coupled to the energy storage device and the charging device for powering the heater. The subsystem comprises a controller configured to be operably coupled to the charging device and to receive one or more sensor signals configured to detect operational conditions of the power system. The controller is configured to control the operation of the charging device, including in a low temperature operating mode when the temperature of the energy storage device is below a charging low temperature set point and the heater powered on. The charging low temperature set point is a temperature at or above a charging low temperature limit of the energy storage device below which the energy storage device should not be charged. The charging low temperature set point may be slightly above the charging low temperature limit of the energy storage device to provide some safety margin above the limit. In the low temperature mode, the controller is configured to control a current output of the charging device to provide at least some of the power required to power the heater while at the same time avoiding a positive current input to the charging device, based on the one or more sensor signals. As explained herein, this reduces, or eliminates, discharging energy from the energy storage device to power the heater, while also keeping the energy storage device from going into a charging state below the charging low temperature limit which can damage the energy storage device.

The controller of the subsystem may have any one or more of the aspects and features described herein for the controller of the power system, and the power system may have any one or more of the aspects and features of the power system as described herein. For example, the controller may be configured to control the current output of the charging device to provide at least 50% or more, or at least 60% or more, or at least 70% or more, or at least 75% or more, or at least 80% or more, or at least 90% or more of the power required to power the heater in the low temperature operating mode, and/or to control the current output of the charging device to power the heater while maintaining a nominal current discharge of the energy storage device.

In another aspect, the controller of the subsystem may be configured to receive the one more sensor signals and the sensor signals may include a current sensor signal representative of the current input or output of the energy storage device and/or a temperature sensor signal representative of the temperature of the energy storage device. The controller is further configured to use the current sensor signal and/or the temperature sensor signal as the one or more sensor signals in controlling the current output of the charging device in the low temperature operating mode

In another aspect, the controller may be configured to communicate with a storage device management system (SDMS). In addition, the controller may be configured to receive a heater status signal from the SDMS representative of the heater status, including whether the heater is on or off, and the controller may use the heater status signal temperature sensor signal as one of the sensor signals in controlling the current output of the charging device in the low temperature operating mode.

In additional aspects of the disclosed embodiments, the energy storage device may have a charging high temperature limit and/or a discharge high temperature limit. In this case, the power system includes a cooling device (i.e., a chiller) thermally coupled to the energy storage device and operably coupled the charging device, energy storage device, controller and/or SDMS. The cooling device is configured to cool the energy storage device. The cooling device may be any suitable device, such as a refrigeration system, evaporative cooling system, cold plate, heat sink, etc., which may also include a cooling fluid for thermally transferring heat from the energy storage device in order to cool the energy storage device. The controller has a high temperature operating mode when the energy storage device temperature is above a charging high temperature set point. The charging high temperature set point is a temperature at or below the charging high temperature limit, such that the set point may provide some safety margin above the limit. In the high temperature operating mode, the cooling device is powered on. In the high temperature operating mode, the controller is configured to control current output of the charging device to provide at least some of the power required to power the cooling device while at the same time avoiding a positive current input to the energy storage device, based on the one or more sensor signals. In other words, the controller controls the current output of the charging device so that the charging device provides at least some power to the cooling device, and also keeps the current output of the charging device below a level that would result in a positive current input to the energy storage device, in which case the energy storage device would go into a charging state above the charging high temperature set point. For example, if the current output of the charging device flowing to the cooling device and energy storage device exceeds the current draw of the cooling device, then the energy storage device will go into a charging state. Accordingly, the controller may prevent the energy storage device from entering a charging state that could damage the battery and/or create a risk of a dangerous condition of the storage device.

In another aspect of the power system, in the high temperature operating mode, the controller may be configured to control the current output of the charging device to power the cooling device while maintaining a nominal current discharge of the energy storage device. In other words, the controller controls the current output of the charging device such that there is at least some small amount of current discharge of the energy storage device. Typically, the nominal current discharge is used to provide some of the power to the heater, but also may be used to power other devices. In other aspects, the nominal current discharge of the energy storage device may be set to 1 amp or less, or 2 amps or less, or 5 amps or less. In this way, the power draw from the energy storage device is limited, so that the amount of energy need to recharge the battery to replenish the energy used to power the cooling device is minimal, while also providing a margin of safety in ensuring that the energy storage device does not enter a charging state when it is above the charging high temperature limit.

In still another aspect, the controller may be configured to control the current output of the charging device to provide at least a minimum amount of the power required to power the cooling device in the high temperature operating mode, such as at least 50% or more, or at least 60% or more, or at least 70% or more, or at least 75% or more, or at least 80% or more, or at least 90% or more of the power required to power the cooling device in the low temperature operating mode.

It should be understood that the power system may include both a heater for use in the low temperature mode and a cooling device for use in the high temperature mode, in which case the controller is configured to operate alternatively in the low temperature mode and the high temperature mode.

### BRIEF DESCRIPTION OF THE DRAWINGS

The foregoing and other aspects of embodiments are described in further detail with reference to the accompanying drawings, wherein like reference numerals refer to like elements and the description for like elements shall be applicable for all described embodiments wherever relevant, wherein:

FIG. 1 is a block diagram of a power system for a rechargeable energy storage device having improved power management at the operational temperature limits of the energy storage device, according to one embodiment of the present invention;

FIG. 2 is a block diagram of a power system for a rechargeable energy storage device having improved power management at the operational temperature limits of the energy storage device, according to another embodiment of the present invention;

FIG. 3 is a block diagram of a power system for a rechargeable energy storage device having improved power management at the operational temperature limits of the energy storage device, according to still another embodiment of the present invention.

### DETAILED DESCRIPTION

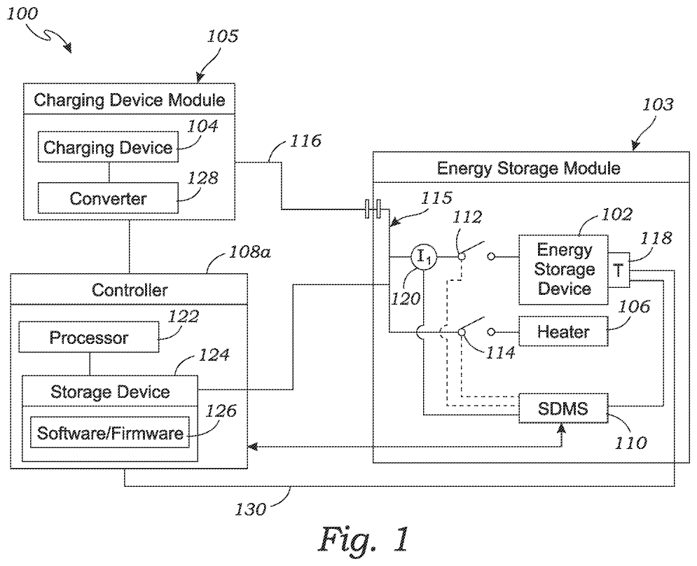

Referring to FIG. 1, a block diagram of one exemplary embodiment of a power system 100 for a rechargeable energy storage device 102 having improved power management at the operational temperature limits of the energy storage device 102 is illustrated. The power system 100 includes the rechargeable energy storage device 102, a charging device 104, a controller 108a, and a heater 106 for heating the rechargeable energy storage device 102. The power system 100 may be used in any application where a rechargeable power source is useful, such as in a home, in a vehicle, such as an automobile, truck, boat, ship, commercial truck, shipping truck, tractor-trailer truck, etc. The power system 100 typically outputs electrical power for powering any suitable electrical device(s), but may also output mechanical/motive power or other types of power.

The rechargeable energy storage device 102 may be any suitable rechargeable device which can store energy, discharge (i.e., output) the stored energy, and be recharged to replenish the stored energy after it has been discharged. For example, the energy storage device 102 may be a battery which stores energy and outputs the stored energy as electrical power, including a rechargeable electrochemical battery, a supercapacitor battery, a solid-state battery, etc. Some examples of suitable electrochemical batteries include a Li-ion battery; a lithium based battery; a lead-acid battery; a LiFePO₄ battery; a Lithium-ion polymer battery; a nickel-cadmium battery; and a nickel-metal hydride battery. These types of energy storage devices, as well as other types, have operational temperature limit, and outside of these limits the energy storage devices cannot be charged and/or discharged or the devices may be damaged or create a risk of dangerous conditions, including, for example, fire, explosion, overheating, electric shock, injuries, and/or damage to connected or nearby items. The operational temperature limits may be low temperature limits, below which the devices should not be discharged or charged, or high temperature limits, above which the devices should not be discharged or charged.

As an example, Li-ion batteries have low temperature limits for discharging the battery and for charging the battery. Typical Li-ion batteries have a charging low temperature limit of about 0° C., because charging at temperatures below 0° C. damages the internal structure of the Li-ion batteries and/or may create a risk of dangerous conditions such as explosion of the batteries. Moreover, many Lithium chemistry batteries exhibit reduced charging capabilities as the temperature approaches 0° C. , and below 0° C. charging must be disabled to prevent damage to the battery. Accordingly, charging of Li-ion batteries below the charging low temperature limit must be avoided. Typical Li-ion batteries also have a discharge low temperature limit of about −20° C., because discharge at temperatures below −20° C. may also damage the batteries and/or pose dangerous conditions. Li-ion batteries also have a charging high temperature limit of about 45° C., and a discharging high temperature limit of about 60° C. The damage to the Li-ion batteries may include a decrease in maximum storage capacity, decreased performance (e.g., decreased power output), diminished lifecyle (number of charge and discharge cycles of battery causing loss of performance) and/or total battery failure.

Other types of batteries made with different chemistries may also have these types of operational temperature limits, but such limits may be at different temperatures. For instance, lead-acid batteries can be safely charged and discharged at temperatures from about −20° C. to about 50° C. without damaging the batteries or creating unsafe conditions. Outside this temperature range, lead-acid batteries may exhibit degraded performance, and/or may be damaged.

In order to operate the power system 100 in ambient conditions beyond the operational temperature limits of the energy storage device 102, the heater 106 is provided to warm the energy storage device 102 and maintain its temperature above the charging low temperature limit. The heater 106 is thermally coupled to the energy storage device 102, such as by a thermally conductive and/or thermally convective relationship. The heater 106 may be any suitable heating device powered by electricity, such as a resistive heater, a heat pump, or the like. The heater 106 is operably coupled to the energy storage device 102 and the charging device 104 for powering the heater 106.

The energy storage device 102 may be a component of an energy storage module 103 which also includes a storage device management system (SDMS) 110 and the heater 106. For instance, the energy storage device module 103 may be an integrated battery module comprising battery cell(s), the SDMS 110 and the heater 106. In such base, the SDMS 110 may be a battery management system (BMS) 110. The SDMS 110 is configured to monitor and control the operation of the energy storage module 103. The SDMS 110 is operably coupled to the energy storage device 102, including via a storage device switch 112 controlled by the SDMS 110 for electrically connecting and disconnecting the energy storage device 102 from a power circuit 115. The power circuit 115 comprises a power wire 116 electrically connected to the charging device 104 and electrical connections to the energy storage device 102 and the heater 106. The SDMS 110 is also operably coupled to the heater 106, including via a heater switch 118 electrically connecting and disconnecting the heater from the power circuit 115.

The SDMS 110 is also operably coupled to a temperature sensor 118 which is thermally coupled to the energy storage device 102 for detecting a temperature of the energy storage device 102. The temperature sensor 118 provides a temperature sensor signal representative of the temperature of the energy storage device 102. The temperature sensor 118 may be any suitable temperature sensor, such as a thermistor, a thermocouple or other sensor for detecting temperature. The SDMS 110 is configured to receive the temperature sensor signal and to control the operation of the energy storage device 102 and heater 106, based on the temperature sensor signal. The SDMS 110 is also operably coupled to a current sensor 120 which is operably coupled to the energy storage device 102 for detecting a current input (in a charging state of the energy storage device 102) or current output (in a discharge state of the energy storage device 102) of the energy storage device 102. The current sensor 120 is operably coupled to the energy storage device 102 and provides a current sensor signal representative of the current input or output of energy storage device 102. The current sensor 120 may be any suitable sensor for detecting current, such as an analog sensor, a shunt sensor, a Hall-effect sensor, etc. The SDMS 110 is also configured to receive the current sensor signal and to control the operation of the energy storage device 102 and heater 106, based on the current sensor signal.

The SDMS 110 is configured to control the heater 106 by opening or closing the switch 114 to connect or disconnect the heater 106 from the power circuit 115. The SDMS 110 is programmed to determine if the temperature of the energy storage device 102 is below a charging low temperature set point based on the temperature sensor signal. The charging low temperature set point is a temperature at or above the charging low temperature limit of the energy storage device 102. The set point may be above the charging low temperature limit of the energy storage device 102 to provide some safety margin above the limit, and/or to prevent the temperature of the energy storage device 102 from falling below the limit by initiating heating of the energy storage device 102 before it hits the limit. The SDMS 110 is also programmed to turn on the heater when the temperature of the energy storage device 102 falls below the charging low temperature set point. Accordingly, when the SDMS 110 determines that the energy storage device 102 needs to be heated based on the temperature sensor signal from the temperature sensor 118, the SDMS 110 turns on the heater by connecting (i.e., closing) the switch 114 to connect the heater 106 to the power circuit 115. This connects the heater 106 to the energy storage device 102 and the charging device 104 to power the heater 106. This operating mode of the power system 100 wherein the temperature of the energy storage device 102 is below the charging low temperature set point and the heater is turned on is referred to as the “low temperature operating mode.” The SDMS 110 may also be programmed to determine and provide a heater status signal (which may also be referred to as a low temperature operating mode signal) which indicates whether the power system is in the low temperature operation mode. The SDMS 110 may be configured to transmit the heater status signal to the controller 108a via a communication system 130, described below.

The SDMS 110 may be programmed to have a safety disconnect when detecting a positive current input into the energy storage device based on the current sensor signal from the current sensor 120, which indicates that the energy storage device 102 has gone into charging state, and the detected temperature from the temperature sensor indicates the temperature of energy storage device 102 is below charging low temperature limit or charging low temperature set point (e.g., when the power system 100 is in the low temperature operating mode). In this case, the SDMS disconnects the energy storage device 102 from the power circuit 115 by opening the switch 112. This safety feature prevents damage to the energy storage device 102 and dangerous conditions of the energy storage device 102.

The SDMS 110 is also programmed to turn off the heater 106 when the temperature sensor signal indicates that the temperature of the energy storage device is above a charging normal temperature set point, which is above the charging low temperature set point. The SDMS 110 turns off the heater 106 by opening the switch 114 to disconnect the heater from the power circuit 115.

The charging device 104 is operably coupled to the energy storage device 102 and is configured to recharge the energy storage device 102. As some examples, the charging device 104 may be an alternator, an alternator and converter 128, a generator, a power supply or other source of power for delivering a charging power (e.g., electric current) to the energy storage device 102. As an example, the charging device 104 may be a diesel generator (AC or DC) in a trailer of a semi-truck. The charging device 104 may also be any suitable power source and a converter, wherein the power source may be an AC powered battery charger, a solar maximum power point tracking (MPPT) charger, a secondary energy storage device (which may be any of the devices described herein for the energy storage device), and the converter 128 may be a DC-DC converter, or an AC-DC converter.

In the case that the charging device 104 is an alternator, the alternator may be an alternator mounted in a vehicle, such as a chassis alternator also used to power the vehicle's electrical systems, or a dedicated alternator used only as the charging device for the energy storage device 102. The charging device 104 may comprise, or be a component of, a charging device module 105 which includes the charging device 104 and a converter 128 for converting the power output of the charging device 104 to an appropriate type of power for charging the charging device 104. For instance, the converter 128 may be a DC-DC converter, a DC-AC converter, an AC-DC converter, a pulse width modulation controller, a current limiting wire, and a current limiting self-resetting device.

The controller 108a is operably coupled to the charging device 114 and/or charging device module 105 for controlling the operation of the charging device 114. The controller 108a comprises a microprocessor 122 (or logic), memory, one or more storage devices 124 (e.g., hard drive, memory, etc.), software and/or firmware 126 which programs the controller 122, input and output connections and buses, and one or more communication adapters. In the embodiment of FIG. 1, the controller 108a is also in communication with the SDMS 110 via a communication system (e.g., a communication link or network) 130. The communication system 130 may be any suitable means of communication between the controller 108a and the SDMS 110, such as a controller area network (CAN), an Ethernet network, an RS-485 network, etc.

The controller 108a is configured to control the operation of the charging device 104 based on sensor signals received by the controller 108a which provide operational conditions of the power system 100. The controller 108a has a low temperature operating mode when the temperature of the energy storage device 102 is below the charging low temperature set point and the heater 106 is turned on. The software/firmware 126 programs the controller 108a to determine the low temperature operating mode based on the sensor signals. In one embodiment, the controller 108a receives the sensor signals from the SDMS 110 via the communication system 130. The sensor signals received by the controller 108a may include one or more of a temperature sensor signal representative of the temperature detected by the temperature sensor 118, a current sensor signal representative of the current detected by the current sensor 120, and/or the heater status signal (low temperature operating mode status signal). In one way, the controller 108a may determine to operate in the low temperature operating mode if the temperature sensor signal indicates that the temperature of the energy storage device 102 is below the charging low temperature set point. Alternatively, or in addition, the controller 108a may determine to operate in the low temperature operating mode if the heater sensor signal indicates that the heater is powered on, which is indicative that SDMS is in the low temperature operating mode wherein the SDMS detects a temperature below the charging low temperature set point and has turned on the heater. The controller 108a may also receive other sensor signals in order to determine whether to operate in the low temperature operating mode. For instance, the controller 108a may be directly, operably coupled to the temperature sensor 118 and may receive the temperature sensor signal directly from the temperature sensor 118, or the controller 108a may be operably coupled to a heater sensor which detects that the heater 106 is powered on, such as by detecting current flow into the heater 106, or other suitable means.

The controller 108a is configured such that when it determines to operate in the low temperature operating mode, the controller 108a monitors and controls the current output of the charging device 104 such that the charging device 104 provides at least some of the power required to power the heater 106 while also avoiding putting the energy storage device 102 into a charging state, based on one or more of the sensor signals. In other words, the current from the charging device 104 flowing to the power circuit 115 is controlled by the controller 108a to be equal or less than the current draw of the heater 106 plus any other current loads on the energy storage device 102. In this way, the net current at the energy storage device 106 is never positive current input into the energy storage device 102, which positive current input would put the energy storage device 102 into a charging state that could damage the battery and/or create a risk of a dangerous condition of the storage device. In order to monitor and control the current output of the charging device 104 to meet this low temperature operating mode, the charging device 104 monitors the current at the energy storage device 102 based on the current sensor signal of the current sensor 120, and uses a closed loop control to control the current output of the charging device 104. Similar to the temperature sensor signal, the controller 108a may be directly, operably coupled to the current sensor 120 and may receive the current temperature sensor signal directly from the current sensor 120.

Since the controller 108a controls the charging device 104 such that it provides at least some of the current to power the heater 106, the amount of current provided by the charging device 104 reduces the power discharge required from the energy storage device 102 to power the heater 106. Indeed, the controller 108a may be programmed such that the charging device 104 provides all, or substantially all, of the power required to power the heater 106, thereby reducing or eliminating the energy discharge of the energy storage device 104. In one embodiment, for example, the controller 108a may be configured to control the current output of the charging device 104 to provide at least a minimum amount of the power required to power the heater 106 in the low temperature operating mode, such as at least 50% or more, or at least 60% or more, or at least 70% or more, or at least 75% or more, or at least 80% or more, or at least 90% or more of the power required to power the heater 106 in the low temperature operating mode. This reduces or eliminates the charging energy and time needed to replenish the energy stored in the energy storage device 102 when the energy storage device 102 is solely used to power the heaters, as in the prior art systems.

In another embodiment, in the low temperature operating mode, the controller 108a may be configured to control the current output of the charging device 104 to provide at least some of the power required to power the heater 106, while maintaining a nominal current discharge of the energy storage device 102. Said another way, the controller 108a controls the current output of the charging device 104 such that there is at least some small amount of current discharge of the energy storage device 102. Usually, the nominal current discharge is used to provide some of the power to the heater 106, but also may be used to power other loads/devices. The nominal current discharge of the energy storage device may be set to 1 amp or less, or 2 amps or less, or 5 amps or less. Thus, the power draw from the energy storage device 102 is minimal, so that the amount of energy need to recharge the energy storage device 102 to replenish the energy used to power the heater 106 is minimal, while also providing a margin of safety in ensuring that the energy storage device 102 does not enter a charging state.

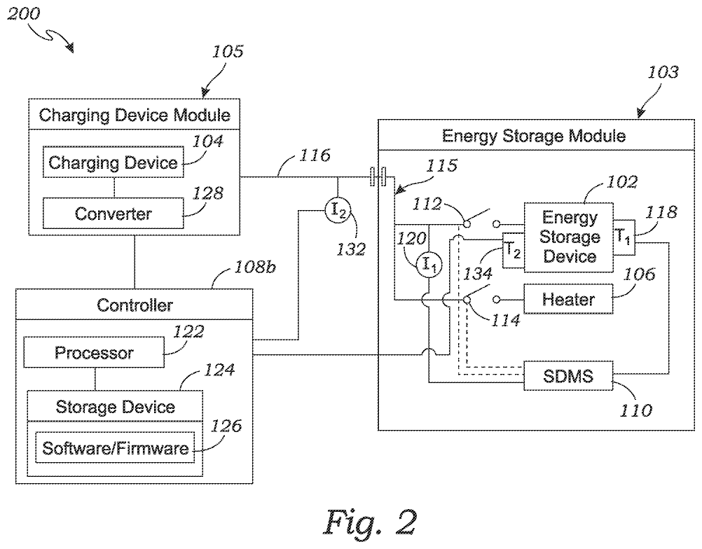

Turning now to FIG. 2, another embodiment of a power system 200 for a rechargeable energy storage device 102 having improved power management at the operational temperature limits of the energy storage device 102 is illustrated. The power system 200 is similar to the power system 100, except that there is no communication link between the SDMS 110 and the controller 108b. Hence, the controller 108b cannot receive the temperature sensor signal and current sensor signal from the internal current sensor 120 and internal temperature sensor 118 of the energy storage module 103, respectively, so that controller 108b directly receives the sensor signals.

In the power system 200, a charging current sensor 132 is operably coupled to the charging device 104, such as on the power wire 116 for detecting the current flowing from the charging device 108b into the power circuit 115. The charging current sensor 132 is also operably coupled to the controller 108b such that the controller 108b receives a charging current sensor signal representative of the current flowing from the charging device 104 into the power circuit 115. A peripheral temperature sensor 134 is operably coupled to the energy storage device 102 or the energy storage module 103 (such as being mounted on an enclosure of the energy storage module 103), to detect the temperature of the energy storage device 102. The peripheral temperature sensor 134 is also operably coupled to the controller 108b such that the controller 108b receives a peripheral temperature sensor signal representative of the temperature of the energy storage device 102.

The controller 108b of the power system 200 is configured substantially similarly to the controller 108a of the power system 100, except that the controller 108b utilizes the peripheral temperature sensor signal and the charging current sensor signal to control the current output of the charging device 104 in the low temperature operating mode. To determine whether to operate in low temperature operating mode, the controller 108b utilizes the peripheral temperature sensor signal from the peripheral temperature sensor 134 to determine if the temperature of the energy storage device 102 is below the charging low temperature set point. If the temperature is below the charging low temperature set point, then the controller 108b operates in the low temperature operating mode, as described herein. In order to control the current output of the charging device 104 to be delivered to the charging circuit 115, the controller 108b uses the charging current sensor signal, and in some cases peripheral temperature sensor signal, to determine the current output of the charging device 104 to provide to the power circuit 115.

Like the controller 108a, the controller 108b is configured such that when it determines to operate in the low temperature operating mode, the controller 108b monitors and controls the current output of the charging device 104 such that the charging device 104 provides at least some of the power required to power the heater 106 while also avoiding putting the energy storage device 102 into a charging state, based on one or more of the sensor signals. In other words, the current from the charging device 104 flowing to the power circuit 115 is controlled by the controller 108 to be equal or less than the current draw of the heater 106 plus any other current loads on the energy storage device 102. In this way, the net current at the energy storage device 106 is never positive current input into the energy storage device 102, which positive current input would put the energy storage device 102 into a charging state that could damage the battery and/or create a risk of a dangerous condition of the storage device.

However, the controller 108b is not receiving the current sensor signal of the current sensor 120, which detects the current input/output of the energy storage device 102, but instead receives the charging current sensor signal which detects the charging current from the charging device 104 flowing to the power circuit 115. Hence, the controller 108b must be programmed to determine or estimate the current draw of the heater 106 (and other loads on the power circuit 115, if any) to determine how much current the charging device 116 must provide to the power circuit 115 in order to avoid putting the energy storage device 102 into a charging state. The controller 108b may be configured and/or programmed to determine the current draw of the heater 106 using specifications of the heater 106 and/or the energy storage module 103. The controller 108b may use a formula or table relating the current draw of the heater 106 to the operating conditions of the heater 106 and/or energy storage module 103. For example, the formula or table may cross reference the current draw of the heater 106 to the temperature of the energy storage device 102 and/or other operating conditions such as the load(s) on the power system 200. The controller 108b may then determine the current draw of the heater 106, and use a closed loop control to control the current output of the charging device 104.

The controller 108b may be configured to function in all other respects same or similar to the controller 108a, including being configured to provide at least a minimum amount of the power required to power the heater 106 in the low temperature operating mode, and/or controlling the current output of the charging device 104 to provide at least some of the power required to power the heater 106, while maintaining a nominal current discharge of the energy storage device 102.

Accordingly, innovative and improved systems, methods and devices for managing power charging systems and energy storage devices, such as a rechargeable batteries, at operational temperature limits of the energy storage device have been disclosed. The systems, methods and devices maintain the safe operation of the energy storage device, while also reducing or even eliminating the charging energy and time needed to replenish the energy stored in the energy storage device 102, when operating at the temperature limits of the energy storage device 102.

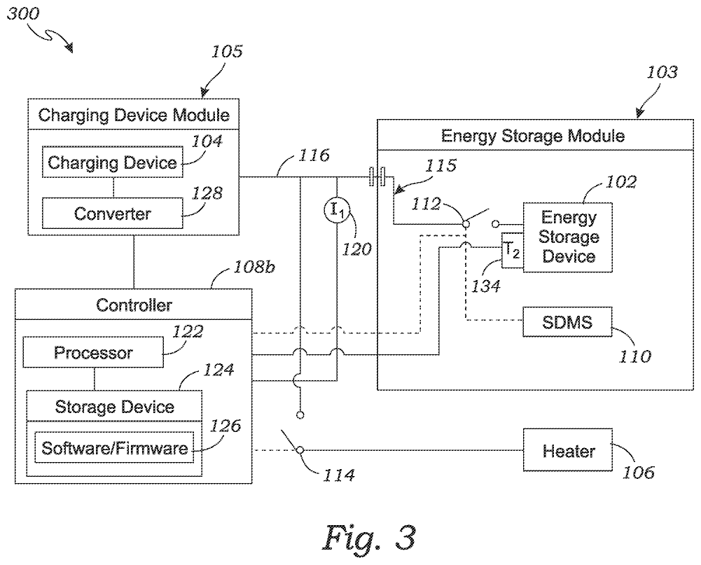

Referring now to FIG. 3, still another embodiment of a power system 300 for a rechargeable energy storage device 102 having improved power management at the operational temperature limits of the energy storage device 102 is illustrated. The power system 300 is similar to the power system 200, except that the heater 106 is an external device to the energy storage module 103, and the turning the heater 106 on and off is controlled by the controller 108b instead of the SDMS 110. In other words, the heater 106 is not integrated with the energy storage module 103 and the heater 106 is not operably coupled to the SDMS 110. The configuration of the power system 300 is typically utilized for energy storage device 102 which do not have a pre-installed heater 106, and also may not have an SDMS 110. Accordingly, the SDMS 110 shown in FIG. 3 for the power system 300 is optional.

In the power system 300, the controller 108b receives the temperature sensor signal from the peripheral temperature sensor 134 so that controller 108b directly receives the peripheral temperature sensor signal from the peripheral temperature sensor 134, and controls turning the heater on and off based on the peripheral temperature sensor signal.

The current sensor 120 in the power system 300 is also different than the charging current sensor 132 in the power system 200 in that the current sensor 120 is positioned in the power circuit 115 such that it detects the current input or output of the energy storage device 102. The current sensor 120 is operably coupled to controller 108b and provides a current sensor signal representative of the current input or output of energy storage device 102.

The controller 108b is configured to control the heater 106 by opening or closing the switch 114 to connect or disconnect the heater 106 from the power circuit 115. The controller 108b is programmed to determine if the temperature of the energy storage device 102 is below the charging low temperature set point based on the peripheral temperature sensor signal. The charging low temperature set point is a temperature at or above the charging low temperature limit of the energy storage device 102. The set point may be above the charging low temperature limit of the energy storage device 102 to provide some safety margin above the limit, and/or to prevent the temperature of the energy storage device 102 from falling below the limit by initiating heating of the energy storage device 102 before it hits the limit. The controller 108b is also programmed to turn on the heater when the temperature of the energy storage device 102 falls below the charging low temperature set point. Accordingly, when the controller 108b determines that the energy storage device 102 needs to be heated based on the temperature sensor signal from the temperature sensor 118, the controller 108b turns on the heater by connecting (i.e., closing) the switch 114 to connect the heater 106 to the power circuit 115. This connects the heater 106 to the energy storage device 102 and the charging device 104 to power the heater 106.

The controller 108b is configured to operate in the low temperature mode in the same manner as described herein for the power system 200.

Any of the power systems 100, 200 and 300 may be configured to cool the energy storage device 102 when the ambient temperature is above a high temperature limit of the energy storage device 102. For instance, energy storage device 102 may have a charging high temperature limit and/or a discharge high temperature limit. In such case, the power system 100, 200 or 300 includes a cooling device (in the place of the heater 106 or operably connected in similar manner in addition to the heater 106) thermally coupled to the energy storage device 102 and operably coupled the charging device 104, energy storage device 102, controller 108 and/or SDMS 110. The cooling device may be any suitable device, such as a refrigeration system, evaporative cooling system, cold plate, heat sink, etc., which may also include a cooling fluid for thermally transferring heat from the energy storage device 102 in order to cool the energy storage device 102. The controller 108 has a high temperature operating mode when the energy storage device temperature is above a charging high temperature set point. The charging high temperature set point is a temperature at or below the charging high temperature limit, such that the set point may provide some safety margin above the limit. In the high temperature operating mode, the cooling device is powered on. In the high temperature operating mode, the controller 108 is configured to control current output of the charging device 104 to provide at least some of the power required to power the cooling device while at the same time avoiding a positive current input to the energy storage device 102, based on the one or more sensor signals. In other words, the controller 108 controls the current output of the charging device 104 so that the charging device provides at least some power to the cooling device, and also keeps the current output of the charging device 104 below a level that would result in a positive current input to the energy storage device 104, in which case the energy storage device 104 would go into a charging state above the charging high temperature set point. For example, if the current output of the charging device flowing to the cooling device and energy storage device 102 exceeds the current draw of the cooling device, then the energy storage device 102 will go into a charging state. Accordingly, the controller 108 prevents the energy storage device from entering a charging state that could damage the battery and/or create a risk of a dangerous condition of the storage device.

In the high temperature operating mode, the controller 108 may be configured to control the current output of the charging device 104 to power the cooling device while maintaining a nominal current discharge of the energy storage device 102. The controller 108 controls the current output of the charging device 104 such that there is at least some small amount of current discharge of the energy storage device 102. The nominal current discharge of the energy storage device 102 may be set to 1 amp or less, or 2 amps or less, or 5 amps or less. In this way, the power draw from the energy storage device 102 is limited, so that the amount of energy need to recharge the energy storage device 102 to replenish the energy used to power the cooling device is minimal, while also providing a margin of safety in ensuring that the energy storage device 102 does not enter a charging state when it is above the charging high temperature limit.

The controller 108 may be configured to control the current output of the charging device 104 to the cooling device such that the charging device 104 provides all, or substantially all, of the power required to power the cooling device, thereby reducing or eliminating the energy discharge of the energy storage device 104. The controller 108a may be configured to control the current output of the charging device 104 to provide at least a minimum amount of the power required to power the cooling device in the high temperature operating mode, such as at least 50% or more, or at least 60% or more, or at least 70% or more, or at least 75% or more, or at least 80% or more, or at least 90% or more of the power required to power the cooling device in the high temperature operating mode. This reduces or eliminates the charging energy and time needed to replenish the energy stored in the energy storage device 102 when the energy storage device 102 is solely used to power the cooling device.

It should be understood that the power system may include both a heater for use in the low temperature mode and a cooling device for use in the high temperature mode, in which case the controller is configured to operate alternatively in the low temperature mode and the high temperature mod.

Although particular embodiments have been shown and described, it is to be understood that the above description is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims. For example, not all of the components described in the embodiments are necessary, and the invention may include any suitable combinations of the described components, and the general shapes and relative sizes of the components of the invention may be modified. Accordingly, embodiments are intended to exemplify alternatives, modifications, and equivalents that may fall within the scope of the claims. The invention, therefore, should not be limited, except to the following claims, and their equivalents.

What is claimed is:

1. A power system comprising:
a rechargeable energy storage device configured to deliver stored energy and to be recharged by inputting energy into the energy storage device, the rechargeable energy storage device having a charging low temperature limit wherein the energy storage device is not to be charged below the charging low temperature limit;
a charging device operably coupled to the rechargeable energy storage device and configured to recharge the energy storage device;
a heater coupled to the energy storage device for heating the energy storage device, the heater operably coupled to the energy storage device and the charging device for powering the heater; and
a controller operably coupled to the charging device and configured to control the operation of the charging device, the controller configured to receive one or more sensor signals configured to detect operational conditions of the power system, wherein in a low temperature operating mode with the energy storage device temperature below the charging low temperature limit and the heater powered on, the controller is configured to control current output of the charging device to provide at least some of the power required to power the heater while at the same time avoiding a positive current input to the energy storage device, based on the one or more sensor signals.

2. The power system of claim 1, wherein in the low temperature operating mode, the controller is configured to control the current output of the charging device to power the heater while maintaining a nominal current discharge of the energy storage device.

3. The power system of claim 2, wherein the nominal current discharge of the energy storage device is 1 amp or less.

4. The power system of claim 2, wherein the nominal current discharge of the energy storage device is 5 amp or less.

5. The power system of claim 1, wherein the controller is configured to control the current output of the charging device to provide at least 50% or more or more of the power required to power the heater in the low temperature operating mode.

6. The power system of claim 1, wherein the controller is configured to control the current output of the charging device to provide at least 75% or more of the power required to power the heater in the low temperature operating mode.

7. The power system of claim 1, wherein the controller is configured to control the current output of the charging device to provide at least 90% or more of the power required to power the heater in the low temperature operating mode.

8. The power system of claim 1, wherein the energy storage device is one of an electrochemical battery, a supercapacitor battery, and a solid-state battery.

9. The power system of claim 8, wherein the energy storage device is an electrochemical battery selected from the group consisting of: a Li-ion battery; a lithium based battery; a lead-acid battery; a LiFePO₄ battery; a Lithium-ion polymer battery; a lithium-titanate-oxide (LTO) battery; a nickel-cadmium battery; and a nickel-metal hydride battery.

10. The power system of claim 1, further comprising:
a current sensor operably coupled to the energy storage device for detecting a current input or output of the energy storage device and providing a current sensor signal; and
wherein the one or more sensor signals includes a sensor signal representative of the current sensor signal.

11. The power system of claim 10, wherein the current sensor is operably connected to the controller and the current sensor provides the current sensor signal directly to the controller.

12. The power system of claim 10, wherein the energy storage device comprises a storage device management system (SDMS) operably coupled to the energy storage device, heater, and current sensor, and the SDMS is configured to receive the current sensor signal and to transmit the sensor signal representative of the detected current to the controller.

13. The power system of claim 12, wherein the sensor signal is transmitted digitally by the SDMS to the controller.

14. The power system of claim 12, wherein the SDMS is in communication with the controller via a communication system.

15. The power system of claim 14, wherein the communication system is one of controller area network (CAN), an Ethernet network or an RS-485 network.

16. The power system of claim 10, wherein the current sensor is one of an analog sensor, a shunt sensor, and a Hall-effect sensor.

17. The power system of claim 1, further comprising a current sensor operably coupled to the controller and configured for detecting a total current from the charging device to the combination of the energy storage device and heater and providing a current sensor signal representative of the detected current; and
wherein the one or more sensor signals includes a sensor signal representative of the current sensor signal.

18. The power system of claim 1, further comprising:
a temperature sensor operably coupled to the energy storage device for detecting the temperature of the energy storage device and providing a temperature sensor signal representative of the detected temperature;
wherein the one or more sensor signals includes the temperature sensor signal representative of the detected temperature; and
wherein the controller is operably coupled to the heater and the controller is configured to turn the heater on when the controller detects that the temperature of the energy storage device is below the charging low temperature limit based on the temperature sensor signal.

19. The power system of claim 1, further comprising a storage device management system (SDMS) in communication with the controller and configured to determine a heater status, including whether the heater is on or off, and to transmit a signal representative of the heater status to the controller; and
wherein the one or more sensor signals includes the signal representative of the heater status.

20. The power system of claim 1, further comprising:
a storage device management system (SDMS) operably coupled to the energy storage device and the heater and configured to control the heater including turning the heater on and off, and the SDMS not in communication with the controller;
a peripheral temperature sensor operably coupled to the energy storage device for detecting the temperature of the energy storage device and operably coupled to the controller for providing a temperature sensor signal representative of the detected temperature to the controller;
a charging current sensor configured to detect a current flowing from the charging device to the combination of the energy storage device and heater, and to provide a charging current sensor signal representative of the detected current to the controller; and
wherein the one or more sensor signals includes the temperature sensor signal representative of the detected temperature and the charging current sensor signal.

21. The power system of claim 1, wherein:
the energy storage device comprises an electrochemical battery; and
the charging device comprises one of an alternator, an AC generator, a DC generator, an AC powered power supply, a solar maximum power point tracking (MPPT) charger, and a secondary electrochemical battery.

22. The power system of claim 21, wherein:
the charging device is one of an alternator an AC generator and a DC generator mounted in a vehicle; and
the electrochemical battery is selected from the group consisting of: a Li-ion battery; a lithium based battery; a lead-acid battery; a LiFePO₄ battery; a Lithium-ion polymer battery; a nickel-cadmium battery; a lithium-titanate-oxide (LTO) battery; and a nickel-metal hydride battery.

23. The power system of claim 1, wherein:
the energy storage device comprises an electrochemical battery; and
the charging device comprises a power device selected from the group consisting of an alternator, an AC generator, a DC generator, an AC powered power supply, a solar maximum power point tracking (MPPT) charger, and a secondary electrochemical battery; and a power conversion device selected from the group consisting of a DC-DC converter, a DC-AC converter, an AC-DC converter, a pulse width modulation controller, a current limiting wire, and a current limiting self-resetting device.

24. A subsystem for a power system comprising a charging device operably coupled to an energy storage device and a heater coupled to the energy storage device for heating the energy storage device, the heater operably coupled to the energy storage device and the charging device for powering the heater, the subsystem comprising:
a controller configured to be operably coupled to the charging device and to receive one or more sensor signals configured to detect operational conditions of the power system; and
wherein the controller is configured to control the operation of the charging device, including in a low temperature operating mode with the energy storage device temperature below a charging low temperature limit of the energy storage device and the heater powered on in which the controller is configured to control current output of the charging device to provide at least some of the power required to power the heater while at the same time avoiding a positive current input to the charging device, based on the one or more sensor signals.

25. The subsystem of claim 24, wherein the controller is configured to control the current output of the charging device to provide at least 50% or more of the power required to power the heater in the low temperature operating mode.

26. The subsystem of claim 25, wherein the controller is configured to control the current output of the charging device to provide at least 75% or more of the power required to power the heater in the low temperature operating mode.

27. The subsystem of claim 25, wherein the controller is configured to control the current output of the charging device to provide at least 90% or more of the power required to power the heater in the low temperature operating mode.

28. The subsystem of claim 24, wherein in the low temperature operating mode, the controller is configured to control the current output of the charging device to power the heater while maintaining a nominal current discharge of the energy storage device.

29. The subsystem of claim 28, wherein the nominal current discharge of the energy storage device is 1 amp or less.

30. The subsystem of claim 28, wherein the nominal current discharge of the energy storage device is 5 amp or less.

31. The subsystem of claim 24, wherein the energy storage device is one of an electrochemical battery, a supercapacitor battery, and a solid-state battery.

32. The subsystem of claim 31, wherein the energy storage device is an electrochemical battery selected from the group consisting of: a Li-ion battery; a lithium based battery; a lead-acid battery; a LiFePO₄ battery; a Lithium-ion polymer battery; a nickel-cadmium battery; a lithium-titanate-oxide (LTO) battery; and a nickel-metal hydride battery.

33. The subsystem of claim 24, wherein the one or more sensor signals includes a current sensor signal representative of the current input or output of the energy storage device.

34. The subsystem of claim 24, wherein the one or more sensor signals includes a temperature sensor signal representative of the temperature of the energy storage device.

35. The subsystem of claim 24, wherein the controller is configured to communicate with a storage device management system (SDMS), and controller is configured to receive a heater status signal from the SDMS representative of the heater status, including whether the heater is on or off; and
wherein the one or more sensor signals includes the signal representative of the heater status.

36. The subsystem of claim 24, wherein:
the energy storage device comprises an electrochemical battery;
the charging device comprises an alternator; and
the controller is configured to control the operation of the alternator, including controlling a current output of the alternator.

37. The subsystem of claim 24, wherein:
the energy storage device comprises an electrochemical battery;
the charging device comprises an alternator and a converter selected from the group consisting of a DC-DC converter, a DC-AC converter, an AC-DC converter, a pulse width modulation controller, a current limiting wire, and a current limiting self-resetting device; and
the controller is configured to control the operation of the alternator and converter, including controlling a current output of the alternator and converter.

38. The subsystem of claim 37, wherein:
the alternator is an alternator mounted in a vehicle; and
the electrochemical battery is selected from the group consisting of: a Li-ion battery; a lithium based battery; a lead-acid battery; a LiFePO₄ battery; a Lithium-ion polymer battery; a nickel-cadmium battery; and a nickel-metal hydride battery.

39. A power system comprising:
a rechargeable energy storage device configured to deliver stored energy and to be recharged by inputting energy into the energy storage device, the rechargeable energy storage device having a charging low temperature limit wherein the energy storage device is not to be charged below the charging low temperature limit;
a charging device operably coupled to the rechargeable energy storage device and configured to recharge the energy storage device;
a heater coupled to the energy storage device for heating the energy storage device, the heater operably coupled to the energy storage device and the charging device for powering the heater;
a current sensor selected from the group consisting of: (1) a current sensor operably coupled to the energy storage device and configured to detect current input and output of the energy storage device and provide a current sensor signal representative of the detected current; and (2) a current sensor operably coupled to a controller and configured to detect a total current from the charging device to the combination of the energy storage device and heater and provide a current sensor signal representative of the detected current;
a temperature sensor operably coupled to the energy storage device for detecting a temperature of the energy storage device and providing a temperature sensor signal representative of the detected temperature; and
the controller operably coupled to the charging device and configured to control the operation of the charging device, the controller configured to receive one or more sensor signals including the current sensor signal and the temperature sensor signal, wherein in a low temperature operating mode with the energy storage device temperature below the charging low temperature limit and the heater powered on, the controller is configured to control current output of the charging device to provide at least some of the power required to power the heater while at the same time avoiding a positive current input to the charging device, based on the one or more sensor signals.

40. The power system of claim 39, wherein in the low temperature operating mode, the controller is configured to control the current output of the charging device to power the heater while maintaining a nominal current discharge of the energy storage device.

41. The power system of claim 40, wherein the nominal current discharge of the energy storage device is 1 amp or less.

42. The power system of claim 41, wherein the nominal current discharge of the energy storage device is 5 amps or less.

43. The power system of claim 39, wherein the controller is configured to control the current output of the charging device to provide at least 75% or more of the power required to power the heater in the low temperature operating mode.

44. The power system of claim 39, wherein the energy storage device is one of an electrochemical battery, a supercapacitor battery, and a solid-state battery.

45. The power system of claim 39, wherein the current sensor is operably connected to the controller and the current sensor provides the current sensor signal directly to the controller.

46. The power system of claim 39, wherein the power system further comprises a storage device management system (SDMS) and the current sensor is operably coupled to the SDMS, and the controller is configured to receive from the SDMS a sensor signal representative of the detected current.

47. The power system of claim 46, wherein the sensor signal representative of the detected current is transmitted digitally by the SDMS to the controller.

48. The power system of claim 47, wherein the SDMS is in communication with the controller via a communication system.

49. The power system of claim 39, wherein the power system further comprises a storage device management system (SDMS) configured to determine a heater status, including whether the heater is on or off, and the controller is configured to receive from the SDMS a signal representative of the heater status; and
wherein the one or more sensor signals includes the signal representative of the heater status.

50. The power system of claim 39, wherein:
the energy storage device comprises an electrochemical battery; and
the charging device comprises an alternator.

51. The power system of claim 50, wherein:
the alternator is an alternator mounted in a vehicle; and
the electrochemical battery is selected from the group consisting of: a Li-ion battery; a lithium based battery; a lead-acid battery; a LiFePO₄ battery; a Lithium-ion polymer battery; a nickel-cadmium battery; a lithium-titanate-oxide (LTO) battery and a nickel-metal hydride battery.

52. The power system of claim 39, wherein:
the energy storage device comprises an electrochemical battery; and
the charging device comprises an alternator and a power conversion device selected from the group consisting of a DC-DC converter, a DC-AC converter, an AC-DC converter, a pulse width modulation controller, a current limiting wire, and a current limiting self-resetting device.
